(19) United States
(12) Patent Application Publication
(10) Pub. No.: US 2016/0317934 A1
(43) Pub. Date: Nov. 3, 2016

(54) GAME SERVER HAVING INTERNAL GAME RESOURCE, METHOD OF PLAYING A GAME USING THE GAME SERVER, AND GAME DEVELOPMENT SYSTEM INCLUDING THE GAME SERVER

(71) Applicant: Masangsoft Inc., Seoul (KR)

(72) Inventor: Chang Jin JEONG, Incheon (KR)

(21) Appl. No.: 14/790,198

(22) Filed: Jul. 2, 2015

(30) Foreign Application Priority Data
Apr. 30, 2015 (KR) 10-2015-0061024

(51) Int. Cl. A63F 13/77; A63F 13/493; A63F 13/30

(52) U.S. Cl. CPC A63F 13/77; A63F 13/30; A63F 13/493

(57) ABSTRACT

A game server having internal game resources is a web-based game server, has internal game resources including at least game space information, item information, object information, and user information, and provides a game resource for a mission to be carried out by a client and a password key for the mission when receiving a request for starting the mission from the client. Therefore, it is possible to maintain a previous game status, even if a user accesses the game with any types of terminals under any circumstances, because it keeps game resource information, and a method of playing a game using the game server.

### CROSS-REFERENCE TO RELATED APPLICATIONS

This application claims the priority of Korean Patent Application No. 10-2015-0061024 filed on Apr. 30, 2015, in the Korean Intellectual Property Office, the disclosure of which is incorporated herein by reference.

### BACKGROUND OF THE INVENTION

1. Field of the Invention

The present invention relates to a game server having internal game resources, a method of playing a game using the same, and a game development system including the same, and more particularly, a game server having internal game resources that can keep the existing game status regardless of the situation of a user terminal when being connected, and a method of playing a game using the same, and a game development system including the same.

2. Description of the Related Art

Game resources for playing games are kept in game clients in the related art. Accordingly, when a user of a game stops the game and accesses and restarts the game in a predetermined time, a situation different from the previous situation is loaded, depending on the type of the game client or the connection status to the game server, so the user cannot play the game in the previous situation when he/she stopped the game.

Further, for all the existing games, game clients and game servers have been developed for each game, and a game developer has had to work with everything from the beginning in order to put a specific function into the game server for developing a specific game.

In addition, games to be developed are developed on the basis of their unique creative planning, so it is difficult for all of game developers to develop specific games that they want to develop using specific development tools.

As one about this matter in the related art, there is Korean Patent Application Publication No. 10-2012-0117053 (Published on Oct. 24, 2012).

### SUMMARY OF THE INVENTION

An aspect of the present invention provides a game server having internal game resources that can maintain a previous game status, even if a user accesses the game with any types of terminals under any circumstances, because it keeps game resource information, and a method of playing a game using the game server.

An aspect of the present invention also provides a game development system including the game server having internal game resources that can reduce the cost and time for developing a game by keeping resources such as worlds, monsters, items, user information used in a game and providing a UI for a game developer to configure desired resources in accordance with specific logics.

According to an aspect of the present invention, there is provided a game server having internal game resources that is a web-based game server, has internal game resources including at least game space information, item information, object information, and user information, and provides a game resource for a mission to be carried out by a client and a password key for the mission when receiving a request for starting the mission from the client.

According to an aspect of the present invention, the game server may include: a communicating unit that performs wire or wireless communication of signals and data between a client and the game server; a condition checking unit that checks a game resource condition of the client when receiving a request for starting a mission through the communicating unit; a logic creating unit that determines a mission corresponding to the game resource condition and creates and provides a game resource to be provided for the client and a password key corresponding to the mission; and a rewarding unit that receives a request for reward for successful mission and a password key for the successful mission from the client and provides reward when the transmitted password key and the received password key are identical.

According to an aspect of the present invention, the game server may further include a storage unit that keeps the game resources and the created password key.

According to an aspect of the present invention, the logic creating unit may create an object that may exist in a game space, when the client enters the specific game space, and a password key for the object which can be obtained when the object is cleared, and provide the object and the password key to the client.

According to an aspect of the present invention, the game resources including game space information, item information, object information, and user information may be stored in advance in the game server by a game developer.

According to an aspect of the present invention, when there is a record of access to the game server of a user in the user information, the game server may provide an environment in which the user can play the game in a situation when the user stopped the game, regardless of the type of the client that the user uses now or the connection environment.

According to an aspect of the present invention, the condition checking unit may check user information including the game space where the user is for performing the requested mission, items that the user can put on, and a position level and an experience level of the user through the client.

According to an aspect of the present invention, there is provided a web-based method of playing a game using a game server having internal game resources that includes: (a) transmitting a request for starting a mission by means of a client to a game server; (b) checking game resource conditions in the client for the mission by means of the game server; (c) determining the mission for the game resource conditions, and creating and providing a game resource to be provided to the client and a password key corresponding to the mission to the client by means of the game server; and (d) receiving a request for reward for clearing the mission and a password key for clearing the mission from the client, and creating reward for clearing the mission when the transmitted password key and the received password key are identical.

According to an aspect of the present invention, in the step (b), user information including the game space where the user is for performing the requested mission, items that the user can put on, and a position level and an experience level of the user through the client may be checked.

According to an aspect of the present invention, the step (c) may include: creating an object that may exist in a game space, when the client enters the specific game space, and a password key for the object which can be obtained when the object is cleared; and providing the object and the password key to the client.

According to an aspect of the present invention, the game resource may include at least game space information, item information, object information, and user information.

According to an aspect of the present invention, there is provided a game development system that includes: the game server having internal game resources; and a game development UI (User Interface) provided inside or outside the game server and receiving game development information to be created in the game server by a game developer.

According to an aspect of the present invention, the game development UI may include; a game setup unit through which a user sets a game level, an object level, default point information, and an object properties as input values; a game object creating unit that receives specifications and properties of a plurality of objects; a game space creating unit that receives game space creation information and information about objects that show up in specific game spaces; and a game item creating unit that receives creation information about various items to be used in a game.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram illustrating a game server having internal game resources and a game development UI (User Interface) for inputting game development information, according to an embodiment of the present invention;

FIG. 2 is a flowchart illustrating a method of playing a game using the game server having internal game resources according to an embodiment of the present invention;

FIG. 3 is a diagram illustrating in detail the functions of the game server having internal game resources illustrated in FIG. 1; and

FIGS. 4 to 7 are diagrams illustrating a game development UI in web-based game development using the game server having internal game resources illustrated in FIG. 1.

### DETAILED DESCRIPTION OF THE PREFERRED EMBODIMENT

The following embodiments provide specific combinations of components and features of the present invention. The components and features may be selective, unless stated specifically. The components or features may not be achieved independently from other components or features. Embodiments of the present invention may be achieved by combining some of the components and/or features. The order of operation described in embodiments of the present invention may be changed. Some of components or features of any embodiments may be included in those of other embodiment, or may be replaced by corresponding components or features of other embodiments.

Embodiments of the present invention can be accomplished in various ways. For example, the embodiments may be achieved by hardware, firmware, software, or combinations of them.

When hardware is used, methods according to embodiments of the present invention may be made by one or more of ASICs (application specific integrated circuits), DSPs (digital signal processors), DSPDs (digital signal processing devices), PLDs (programmable logic devices), FPGAs (field programmable gate arrays), processors, controllers, microcontrollers, microprocessors, and the like.

When firmware or software is used, methods according to embodiments of the present invention may be made in the type of a module, a procedure, or a function for carrying out function or operations described above. Software codes may be kept in a memory unit and activated by a processor. The memory unit may be provided inside or outside the processor and may transmit/receive data to/from the processor in various ways well known in the art.

Throughout this specification, a case in which any one part is connected with the other part includes a case in which the parts are directly connected with each other and a case in which the parts are electrically connected with each other with other elements interposed therebetween. Further, unless explicitly described otherwise, “comprising” any components will be understood to imply the inclusion of other components rather than the exclusion of any other components.

Further, in the specification, the term “module” means one unit for processing specific functions or operations and may be achieved by hardware, software, or a combination of hardware and software.

Specific terminologies stated hereafter are provided for understanding the present invention and may be used in various ways without departing from the spirit of the present invention.

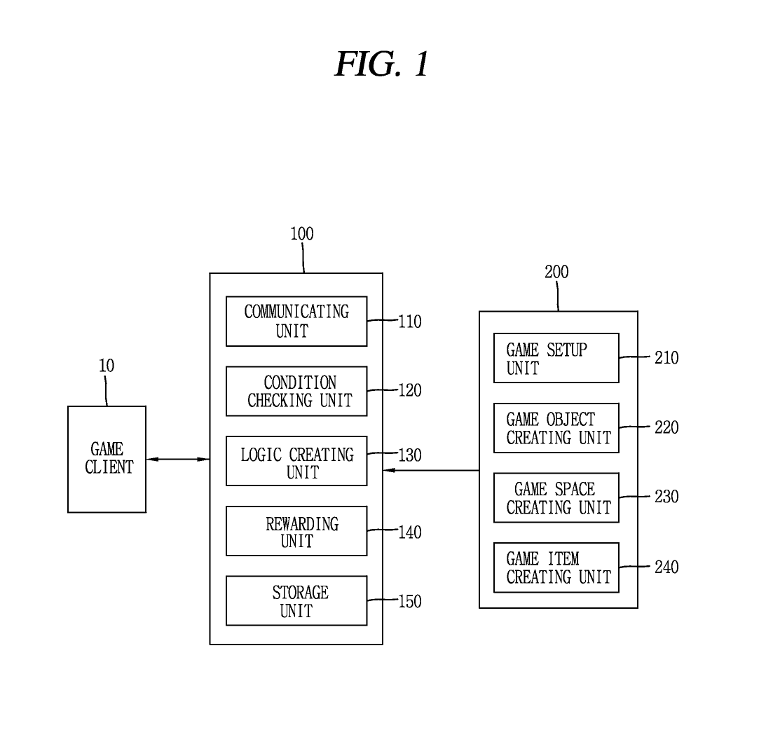

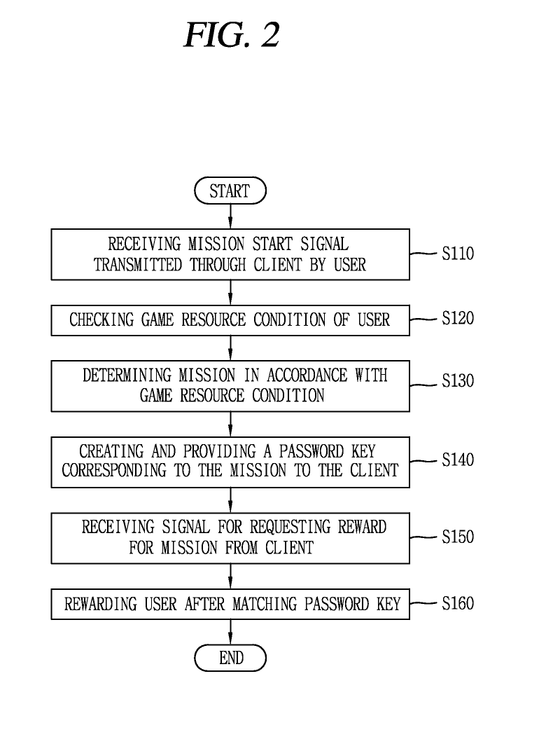

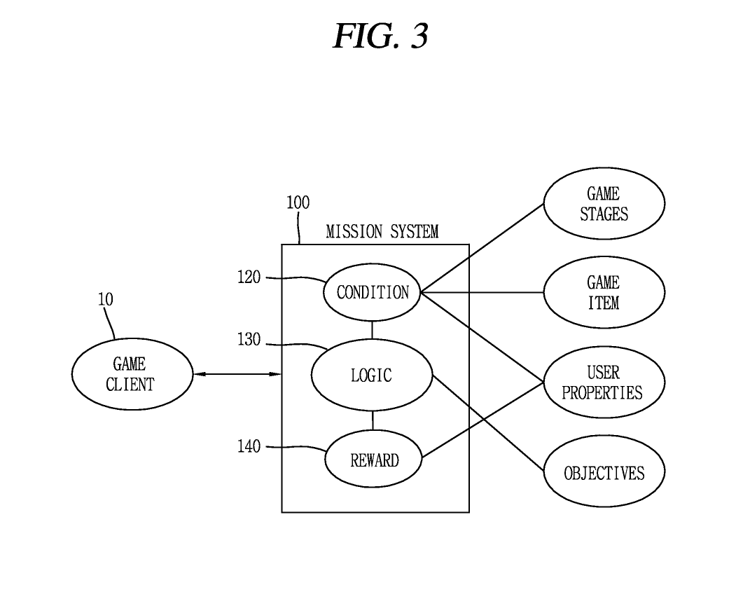

FIG. 1 is a block diagram illustrating a game server having internal game resources and a game development UI (User Interface) for inputting game development information, according to an embodiment of the present invention and FIG. 2 is a flowchart illustrating a method of playing a game using the game server having internal game resources according to an embodiment of the present invention. FIG. 3 is a diagram illustrating in detail the functions of the game server having internal game resources illustrated in FIG. 1 and FIGS. 4 to 7 are diagrams illustrating a game development UI in web-based game development using the game server having internal game resources illustrated in FIG. 1.

Referring to FIGS. 1 and 2, a game server 100 having internal game resources according to an embodiment of the present invention, which is a web-based game server, has internal game resources including at least game space information, item information, object information, and user information, and when it receives a request for starting a mission from the client, it provides a game resource for the mission to be carried out by the client and a password key for the mission.

The game server 100 having internal game resources includes: a communicating unit 110 that performs wire or wireless communication of signals and data between a client 10 and the game server 100; a condition checking unit 120 that checks a game resource condition of the client when receiving a request for starting a mission through the communicating unit 110; a logic creating unit 130 that determines a mission corresponding to the game resource condition and creates and provides a game resource to be provided for the client 10 and a password key corresponding to the mission; and a rewarding unit 140 that receives a request for reward for successful mission and a password key for the successful mission from the client and provides reward when the transmitted password key and the received password key are identical.

The game server 100 having internal game resources further includes a storage unit 150 that keeps the game resources and the created password key, and the game resources including game space information, item information, object information, and user information may be stored in advance in the storage unit 150 of the game server 100 by a game developer.

The logic creating unit 130 creates an object that may exist in a game space, when the client 10 enters the specific game space and a password key for the object which can be obtained when the object is cleared and provides them to the client 10.

When there is a record of access of a user, the game server 100 provides an environment in which the user can play the game in the situation when the user stopped the game, regardless of the type of the client 10 that the user uses now or the connection environment.

The condition checking unit 120 checks user information including the game space where the user is to perform the requested mission, items that the user can put on, and the position level and experience level of the user through the client 10.

According to an embodiment of the present invention, resources such as worlds, monsters, items, and user information that are used in games are kept in the server and a UI for a game developer to configure the resources in accordance with specific logics can be provided and used for the games.

According to an embodiment of the present invention, game server logics are implemented in various ways so that a user receives a specific mission, carries out the mission, and receives reward for success of the mission, and FIG. 3 illustrates a detailed method of making a logic.

In detail, referring to FIG. 3, when a game user starts a specific mission at a specific game stage in the game client 10, the client 10 requests the game server 100 to perform the mission. When a request for performing the mission is received from the game client 10, the condition checking unit 120 of the game server 100 checks first the condition of the game client 10.

Checking of the condition is to determine whether the user has conditions for performing the mission by checking game level of the user and equipment of the user, and when the user is not at the level for the mission or does not have specific equipment, a message saying that the user is not ready to perform the mission is transmitted to the game client 10. It designates conditions for performing the mission and also prevents malicious hacking by the user.

If the user can perform the mission, the game server 100 configures an object (for example, a monster) for the mission through the logic creating unit 130, creates a serial of the monster, and transmits the serial to the game client 120, and the game user receives the serial and performs the mission. The reason for issuing a serial is to enhance security when the mission is performed. When the mission is cleared, the game client 10 transmits a signal saying that the mission has been cleared and the serial received from the game server 100 to the game server 100 and the game server 100 actually determines that the mission has been cleared.

When the mission is cleared, the rewarding unit 140 creates and provides reward to the user and the reward can be made in advance by the game developer through a game development UI 200, which is described below.

First, in order to make a game, there are need for 1) a play space (a world or a stage) for playing the game, 2) information about such as items (spear, sword, shield) of a user, 3) experience level and position level of the user, and 4) an object (monster) that the user is supposed to get.

In the present invention, since the game is supposed to be in the previous situation, even if a user accesses the game with any types of terminals in any situations, the game resource information of the conditions 1), 2), 3), and 4) is kept in the game server 100 for a game developer to develop the game. It is different from the existing games in which game resources for playing a game are kept in the game client 10 and the game is played in a different situation in accordance with the type of the game client or the situation of accessing the game server.

When a user starts a mission, the game server 100 is supposed to select an appropriate monster (object) for the mission and provides it to the game client 10, so it receives a request from the game client 10 through the communicating unit 110 (S110).

The game server 100 checks the stage where the user is, the items of the user, the position level of the user, and the experience level of the user through the condition checking unit 120, queries an appropriate monster for these conditions (S120 and S130), issues and transmits a serial for a unique value of the mission for getting the monster to the game client 10 through the logic creating unit 130 (S140).

The game server makes a mission and issues and transmits a separate serial to the user is for determining whether a request is correct or not, when a wrong request saying that the monster has been caught even though unspecified persons have not got the monster in a game later is transmitted to the server.

When a game user got a monster while playing the game through the game client 10, the game client 10 transmits a serial and user information that have been previously received, to the game server 100 to reward the user for finishing the mission. In this case, the rewarding unit 140 receives a request for reward and a password key for clearing the mission from the game client 10 and determines the password key and the transmitted password key are identical. When they are identical, the rewarding unit 140 creates reward for clearing the mission and transmits it to the game client 10 through the communicating unit 110.

A method of playing a game according to an embodiment of the present invention is described in detail hereafter.

A user accesses the game server 100 through the client 10, starts a game, enters a specific stage, and starts a mission required in the game. For example, in a role playing game (RPG), when a user enters a specific world, the user starts a mission for catching a specific monster.

When a user enters specific world, the game server 100 creates a monster for the world and issues and transmits a serial (issue password key) for the mission to the game client 10.

When the user performing the mission catches the monster, he/she transmits the serial (identification password key) received from the game server 100 and his/her information to the game server 100.

When the issue password key and the identification password key are identical, the game server 100 determines that the mission has been cleared, and rewards the user for clearing the mission. The reward includes improvement of the position level of the user, reward for the experience level of the user, and a specific item.

A game development system including the game sever 100 having internal game resources is described hereafter with reference to FIGS. 1 to 7.

The game development system includes the game server 100 and a game development UI (User Interface) 200 that is disposed inside or outside the game server 100 for a game developer to input game development information to be created in the game server 100.

The game development UI 200 includes a game setup unit 210 through which a user sets a game level, an object level, default point information, and an object properties as input values, a game object creating unit 220 that receives specifications and properties of a plurality of objects, a game space creating unit 230 that receives game space creation information and the information about objects that show up in specific game spaces, and a game item creating unit 240 that receives creation information about various items to be used in a game.

In order to executing the game development system, a game developer has to keep in advance game resources and mission logics in the game server 100. To this end, there is a need for a specific CMS page for the game developer.

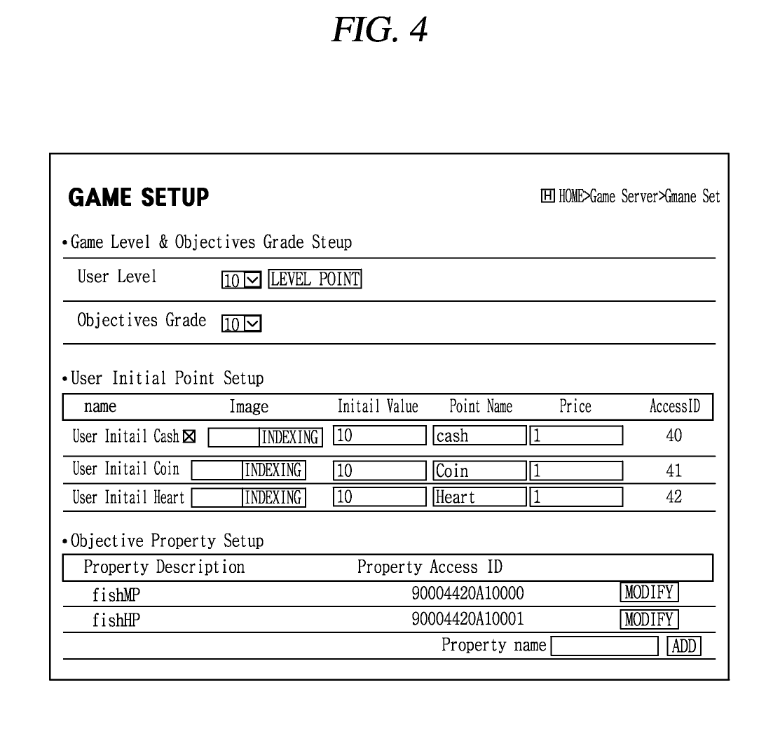

The followings are required for a game developer to use the logics in a game through the game development system (see FIG. 4).

1) A game developer has to register data including resources through a separate content management system (CMS) page in order to register a game mission on the game server 100 through the game development UI 200.

2) A game developer accesses a separate web page using his/her ID and password.

3) A game developer sets general conditions to be used in a game using the game development UI 200.

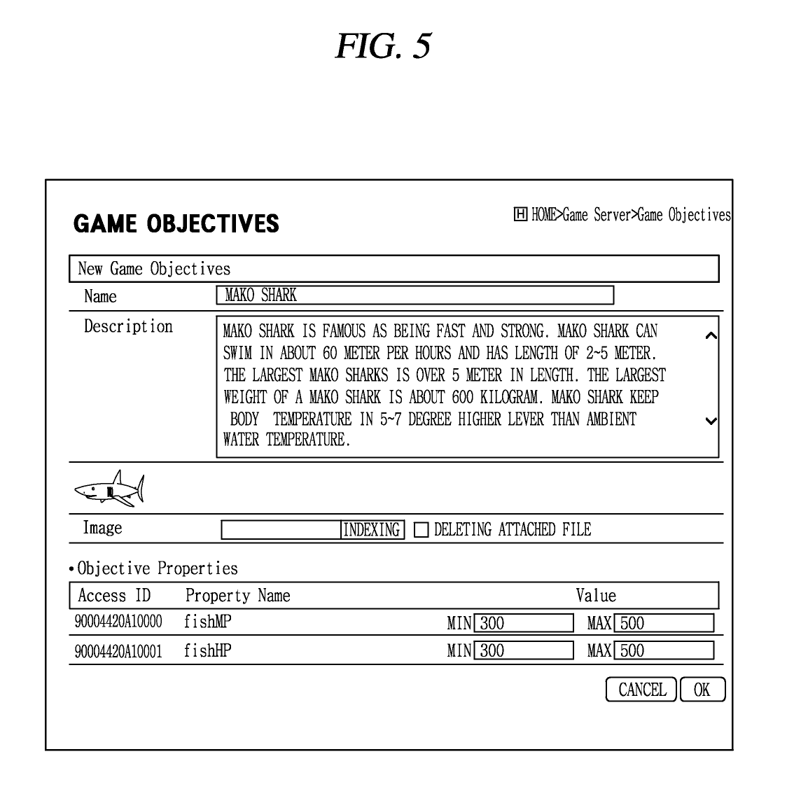

Referring to FIG. 5, a game developer inputs general factors, such as the position level of a user for a game, objective (monster) level configuration, the point initially given to a user, properties of objects, through the game setup unit 210 of the game development UI 200.

Next, the game developer inputs resources about game objects, in detail, specification and properties of each objects (monsters), through the game object creating unit 220 of the game development UI 200.

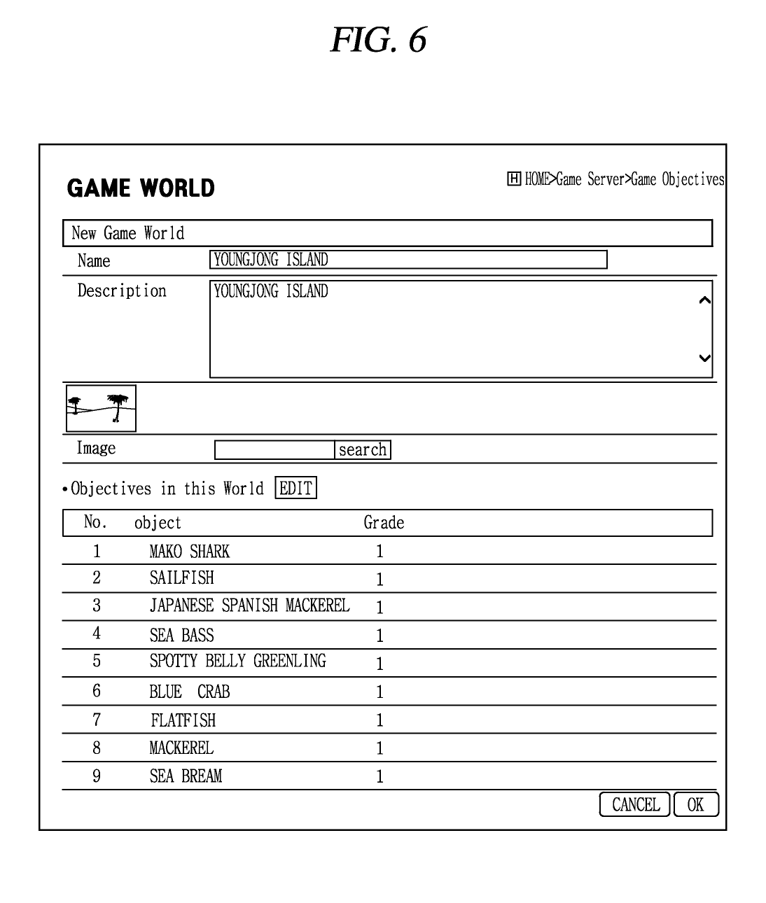

Referring to FIG. 6, the game developer makes a game world through the game space creating unit 230 of the game development UI 200. The game world is a space where a user meets objectives (monsters) in a game to actually enjoy the game, and objects to show up are arranged in the world.

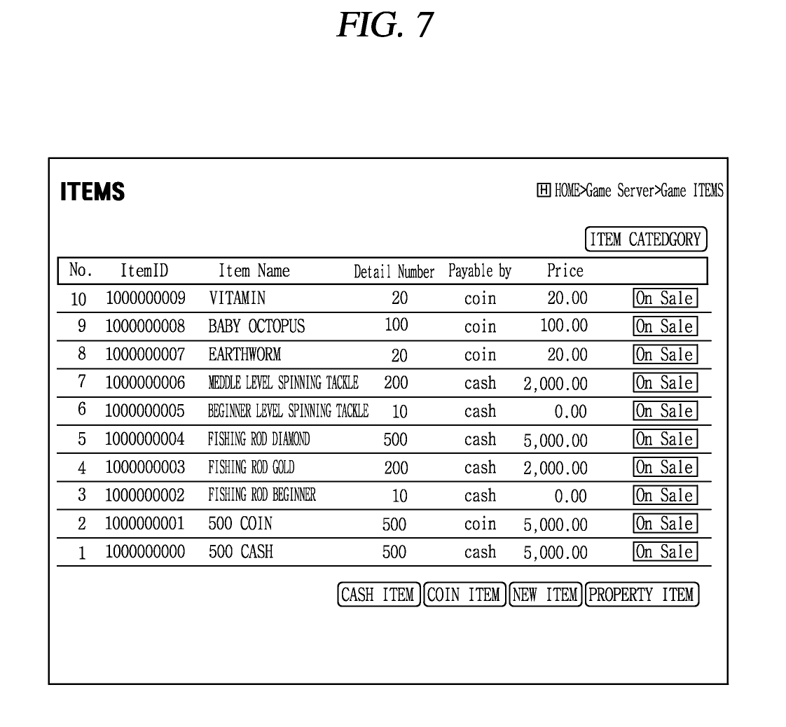

Referring to FIG. 7, the game developer registers various items to be used in a game, such as a spear, a sword, a shield, and a nutrient, through the item creating unit 240 of the game development UI 200 and a user gets or purchases the items in the game.

When there is provided cyber cash in the game, the items can be purchased only by actual money, but specific items can be purchased not by the cyber cash, but only by specific points in the game. Items to be used in games that can be developed in accordance with the present invention may include the followings.

Cash item: Item available only by actual money

Point item: Point available only by cash purchased by actual money

General item: Equipment items such as a sword, a spear, and a shield, available by cash or points

Property item: Item increasing specific properties such as experience level of user

The game developer inputs matters through the game development UI 200, such as which level a game user can perform a mission at, which world the mission is performed in, which objectives (monsters) are to be shown up, and whether the objectives are called randomly or by specific probable values. Further, the user inputs which reward is provided when the mission is cleared. The reward may be made by increasing a specific point of the user or provide the specific items in FIG. 6.

Since a game client and a game sever were developed for each game in the art, a game developer feels a load in developing because he/she has to work with everything from the beginning in order to put a sever function. Games are developed on the basis of their unique creative planning, so it is difficult to develop the games using specific development tools.

However, according to the game development system of the present invention, the function of the game sever that is used in a game is diagrammatized and made be useful for various games, so when a developer uses a framework, he/she can easily insert the server function into the game without separately developing a server.

Further, according to the game development system of the present invention, when a developer simply defines game resources through a CMS, not programming in a server to develop a game server function, API for inputting/outputting the resources is automatically created, so it is possible to achieve the function in a game without developing a specific server.

The above description is an example that explains the spirit of the present invention and may be changed, modified, and replaced in various ways without departing from the basic features of the present invention by those skilled in the art. Accordingly, the embodiment described herein and the accompanying drawings are provided not to limit, but to explain the spirit of the present invention and the spirit and the scope of the present invention are not limited by the embodiments and the accompanying drawings. The protective range of the present invention should be construed on the basis of claims and all the technical spirits in the equivalent range should be construed as being included in the scope of the right of the present invention. Further, embodiments may be made by combining claims not specifically depending on other claims or they may be included in new claims by amendment

As set forth above, according to exemplary embodiments of the invention, it is possible to maintain a previous game status, even if a user accesses the game with any types of terminals under any circumstances, because it keeps game resource information, and a method of playing a game using the game server.

Further, according to exemplary embodiments of the invention, since mission is configured and a separate serial corresponding to the mission is issued and transmitted to a user, it is possible to whether a request saying that the mission has been cleared from the client is made by hacking, an error or the like, or made normally.

Further, according to exemplary embodiments of the invention, resources such as worlds, monsters, items, and user information that are used in games are kept in the server and a UI for a game developer to configure the resources in accordance with specific logics is provided, so it is possible to reduce the cost and time for developing a game.

While the present invention has been illustrated and described in connection with the exemplary embodiments, it will be apparent to those skilled in the art that modifications and variations can be made without departing from the spirit and scope of the invention as defined by the appended claims.

What is claimed is:

1. A game server having internal game resources that is a web-based game server, has internal game resources including at least game space information, item information, object information, and user information, and provides a game resource for a mission to be carried out by a client and a password key for the mission when receiving a request for starting the mission from the client.

2. The game server of claim 1, comprising:
a communicating unit that performs wire or wireless communication of signals and data between a client and the game server;
a condition checking unit that checks a game resource condition of the client when receiving a request for starting a mission through the communicating unit;
a logic creating unit that determines a mission corresponding to the game resource condition and creates and provides a game resource to be provided for the client and a password key corresponding to the mission; and
a rewarding unit that receives a request for reward for successful mission and a password key for the successful mission from the client and provides reward when the transmitted password key and the received password key are identical.

3. The game server of claim 2, further comprising a storage unit that keeps the game resources and the created password key.

4. The game server of claim 2, wherein the logic creating unit creates an object that may exist in a game space, when the client enters the specific game space, and a password key for the object which can be obtained when the object is cleared, and provides the object and the password key to the client.

5. The game server of claim 1, wherein the game resources including game space information, item information, object information, and user information are stored in advance in the game server by a game developer.

6. The game server of claim 1, wherein when there is a record of access to the game server of a user in the user information, the game server provides an environment in which the user can play the game in a situation when the user stopped the game, regardless of the type of the client that the user uses now or the connection environment.

7. The game server of claim 2, wherein the condition checking unit checks user information including the game space where the user is for performing the requested mission, items that the user can put on, and a position level and an experience level of the user through the client.

8. A web-based method of playing a game using a game server having internal game resources, the method comprising:
(a) transmitting a request for starting a mission by means of a client to a game server;
(b) checking game resource conditions in the client for the mission by means of the game server;
(c) determining the mission for the game resource conditions, and creating and providing a game resource to be provided to the client and a password key corresponding to the mission to the client by means of the game server; and
(d) receiving a request for reward for clearing the mission and a password key for clearing the mission from the client, and creating reward for clearing the mission when the transmitted password key and the received password key are identical.

9. The method of claim 8, wherein in the step (b), user information including the game space where the user is for performing the requested mission, items that the user can put on, and a position level and an experience level of the user through the client is checked.

10. The method of claim 8, wherein the step (c) includes:
creating an object that may exist in a game space, when the client enters the specific game space, and a password key for the object which can be obtained when the object is cleared; and
providing the object and the password key to the client.

11. The method of claim 8, wherein the game resource includes at least game space information, item information, object information, and user information.

12. A game development system comprising:
a game server having internal game resources that is a web-based game server, has internal game resources including at least game space information, item information, object information, and user information, and provides a game resource for a mission to be carried out by a client and a password key for the mission when receiving a request for starting the mission from the client; and
a game development UI (User Interface) provided inside or outside the game server and receiving game development information to be created in the game server by a game developer.

13. The system of claim 12, comprising:
a communicating unit that performs wire or wireless communication of signals and data between a client and the game server;
a condition checking unit that checks a game resource condition of the client when receiving a request for starting a mission through the communicating unit;
a logic creating unit that determines a mission corresponding to the game resource condition and creates and provides a game resource to be provided for the client and a password key corresponding to the mission; and
a rewarding unit that receives a request for reward for successful mission and a password key for the successful mission from the client and provides reward when the transmitted password key and the received password key are identical.

14. The system of claim 13, further comprising a storage unit that keeps the game resources and the created password key.

15. The system of claim 13, wherein the logic creating unit creates an object that may exist in a game space, when the client enters the specific game space, and a password key for the object which can be obtained when the object is cleared, and provides the object and the password key to the client.

16. The system of claim 12, wherein the game resources including game space information, item information, object information, and user information are stored in advance in the game server by a game developer.

17. The system of claim 12, wherein when there is a record of access to the game server of a user in the user information, the game server provides an environment in which the user can play the game in a situation when the user stopped the game, regardless of the type of the client that the user uses now or the connection environment.

18. The system of claim 13, wherein the condition checking unit checks user information including the game space where the user is for performing the requested mission, items that the user can put on, and a position level and an experience level of the user through the client.

19. The system of claim 12, wherein the game development UI includes;
a game setup unit through which a user sets a game level, an object level, default point information, and an object properties as input values;
a game object creating unit that receives specifications and properties of a plurality of objects;
a game space creating unit that receives game space creation information and information about objects that show up in specific game spaces; and
a game item creating unit that receives creation information about various items to be used in a game.
